(19) United States
(12) Patent Application Publication
(10) Pub. No.: US 2025/0392186 A1
(43) Pub. Date: Dec. 25, 2025

(54) ELECTROMECHANICAL ACTUATOR, SHADING DEVICE COMPRISING SUCH AN ACTUATOR AND METHOD FOR MANUFACTURING SUCH AN ACTUATOR

(71) Applicant: SOMFY ACTIVITES SA, CLUSES (FR)

(72) Inventors: Florian DOCHE, CLUSES (FR); Clément BERDAT, CLUSES (FR)

(21) Appl. No.: 19/239,601

(22) Filed: Jun. 16, 2025

(30) Foreign Application Priority Data
Jun. 19, 2024 (FR) 2406567

(51) Int. Cl. H02K 5/16; H02K 5/24

(52) U.S. Cl. CPC H02K 5/161; H02K 5/24

(57) ABSTRACT

An electromechanical actuator (11) comprises an electric motor (16), which comprises a bearing (32), a flange (40) and an annular elastic seal (42). The flange (40) comprises a housing (41), which comprises an entry opening (52), a shoulder (46) and notches (47). The bearing (32) is arranged inside the housing (41). Each of the notches (47) is provided in an internal surface (44) of the housing (41). The seal (42) is arranged around the bearing (32) and is compressed between the internal surface (44) of the housing (41) and an external surface (45) of the bearing (32). Each of the notches (47) extends from the shoulder (46) of the housing (41) over a predetermined distance (D47), strictly less than a length (L1) measured between the shoulder (46) and the entry opening (52). Furthermore, the seal (42) is introduced inside the notches (47), in a position of the seal (42) inserted inside the housing (41), so that the annular elastic seal (42) relaxes locally inside these notches (47).

The present invention relates to an electromechanical actuator for a shading device, in other words an electromechanical actuator of a shading device.

The present invention also relates to a shading device comprising a screen driven in displacement by such an electromechanical actuator, as well as a method for manufacturing such an electromechanical actuator.

In general, the present invention relates to the field of shading devices that comprise a motorized driving device moving a screen, between at least one first position and at least one second position.

A motorized driving device comprises an electromechanical actuator of a movable element for closure, shading, or solar protection such as a shutter, a door, a gate, a blind or any equivalent material, hereafter called a screen.

The document EP 2 922 183 A1 is already known, which describes an electromechanical actuator for a shading device. The electromechanical actuator comprises an electric motor. The electric motor comprises a rotor, a stator, a bearing, a stator body and an annular elastic seal. The rotor comprises a shaft. The rotor and the stator are positioned coaxially around a rotation axis. The bearing comprises an external surface. The shaft is supported by the bearing. The stator body comprises a housing. The housing comprises an internal surface, an entry opening, a shoulder and a plurality of notches. The bearing is arranged inside the housing. Each of the notches is provided in the internal surface of the housing. The annular elastic seal is arranged around the bearing. The annular elastic seal is compressed between the internal surface of the stator body housing and the external surface of the bearing. This electromechanical actuator generally provides satisfaction.

In the absence of an annular elastic seal around the bearing, when the shaft of the rotor and the bearing are aligned according to the rotation axis, a play between them generates operational noise and, in particular, a clattering of the electric motor.

Furthermore, when the bearing is mounted fixedly inside the housing of the stator body, misalignments are present between the shaft of the rotor and the bearing, generating friction and, consequently, operational noise and efficiency losses of the electric motor.

To counter this operational noise and, in particular, the clattering of the electric motor, the addition of the annular elastic seal around the bearing allows to obtain a ball joint connection and, more particularly, damping between the bearing and the housing of the stator body.

However, this electromechanical actuator presents, on one hand, the disadvantage that the notches of the housing of the stator body are only introduction notches, which are provided at the entry opening of the housing of the stator body and, on the other hand, the disadvantage that the internal surface of the housing of the stator body is solid over the rest of its length between the introduction notches and the stop.

Thus, during the introduction of the annular elastic seal, which is assembled on the bearing, inside the housing of the stator body, the annular elastic seal relaxes in the introduction notches. Then, the annular elastic seal is pinched between the external surface of the bearing and the internal surface of the stator body, throughout the insertion path of the annular elastic seal inside the housing of the stator body.

In this way, the annular elastic seal twists and can tear due to a shearing force, during the insertion path of the annular elastic seal inside the housing of the stator body.

Consequently, the annular elastic seal may be poorly positioned, or even damaged, following the insertion of the annular elastic seal inside the housing of the stator body.

This poor positioning and/or damage of the annular elastic seal causes a misalignment of the bearing relative to the shaft of the rotor and results in an assembly defect of the electric motor, which can be either a crimping defect at the entry opening of the housing of the stator body, or an inability to mount the shaft of the rotor in the bearing.

To address these positioning and/or damaging issues of the annular elastic seal, a lubrication operation of the housing of the stator body is implemented before the insertion of the annular elastic seal inside the housing of the stator body.

Such a lubrication operation of the housing of the stator body increases the cost of obtaining the electric motor.

Moreover, the introduction notches function to prevent rotation of the bearing around the rotation axis.

The present invention aims to resolve the aforementioned disadvantages and to propose an electromechanical actuator for a shading device, a shading device comprising such an electromechanical actuator, as well as a method for manufacturing such an electromechanical actuator, allowing, on one hand, to ensure the assembly compliance of an annular elastic seal, which is assembled on a first bearing, inside a first housing of a first flange and, on the other hand, to minimize an operational noise level of the electric motor.

In this respect, the aim of the present invention, according to a first aspect, is an electromechanical actuator for a shading device, the electromechanical actuator comprising at least one electric motor, the electric motor comprising at least:
a rotor, the rotor comprising at least a shaft,
a stator, the rotor and the stator being positioned coaxially around a rotation axis,
a first bearing, the first bearing comprising an external surface, the shaft being supported by the first bearing,
a first flange, the first flange comprising at least a first housing, the first housing comprising at least an internal surface, an entry opening, a first shoulder and a plurality of notches, the first bearing being arranged inside the first housing, each of the notches being provided in the internal surface of the first housing, and
an annular elastic seal, the annular elastic seal being arranged around the first bearing, the annular elastic seal being compressed between the internal surface of the first housing of the first flange and the external surface of the first bearing.

According to the invention, each of the notches extends from the first shoulder toward the entry opening over a first predetermined distance, according to the direction of the rotation axis, the first predetermined distance being strictly less than a first length measured between the first shoulder and the entry opening, according to the direction of the rotation axis. Furthermore, the annular elastic seal is introduced inside the notches, in a position of the annular elastic seal inserted inside the first housing of the first flange, so that the annular elastic seal relaxes locally inside these notches.

Thus, this construction of the electric motor allows, on one hand, to ensure the assembly compliance of the annular elastic seal, which is assembled on the first bearing, inside the first housing of the first flange and, on the other hand, to minimize an operational noise level of the electric motor.

In this way, the annular elastic seal can be inserted from the entry opening of the first housing to the notches provided in the internal surface of the first housing, so that the annular elastic seal relaxes locally inside these notches.

The notches are therefore present only at the end of the insertion path of the annular elastic seal inside the first housing of the first flange.

Consequently, these notches do not cause twisting, or, eventually, tearing of the annular elastic seal, during the insertion of the annular elastic seal, which is assembled on the first bearing, inside the first housing of the first flange.

Furthermore, the positioning of the annular elastic seal in the notches provided in the internal surface of the first housing allows to ensure the maintenance in position of the first bearing relative to the first housing, in particular according to the direction of the rotation axis, whether during the operation of the electric motor or when falling of it during a handling operation.

Moreover, the compression of a part of the annular elastic seal between the internal surface of the first housing of the first flange and the external surface of the first bearing, in other words the maintenance in position of the part of the annular elastic seal outside the notches provided in the internal surface of the first housing, allows to obtain a ball joint connection and, more particularly, damping between the first bearing and the first housing of the first flange.

According to an advantageous feature of the invention, the first bearing comprises a second shoulder. Furthermore, the annular elastic seal is arranged between the first shoulder and the second shoulder.

According to another advantageous feature of the invention, the first bearing is a bushing.

According to another advantageous feature of the invention, the electric motor further comprises:
a second bearing, the shaft being supported by the second bearing, and
a second flange, the second flange comprising a second housing, the second bearing being arranged inside the second housing.

According to another advantageous feature of the invention, the second bearing is a rolling bearing.

According to another advantageous feature of the invention, a part of the external surface of the first bearing forms an introduction slope, so as to introduce the annular elastic seal onto the external surface of the first bearing, the introduction slope extending over a second predetermined distance from one end of the first bearing toward the first shoulder, according to the direction of the rotation axis.

According to another advantageous feature of the invention, at least a part of the internal surface of the first housing forms a guiding slope, so as to guide the annular elastic seal against the internal surface of the first housing.

According to another advantageous feature of the invention, the entry opening of the first housing comprises a chamfer.

The aim of the present invention, according to a second aspect, is a shading device, the shading device comprising at least:
a screen, and
an electromechanical actuator, according to the invention and as mentioned above, the screen being driven in displacement by the electromechanical actuator.

This shading device presents features and advantages similar to those described previously, in relation to the electromechanical actuator according to the invention.

The aim of the present invention, according to a third aspect, is a method for manufacturing an electromechanical actuator, according to the invention and as mentioned above.

The method comprises at least the following steps:
a step of assembling the annular elastic seal around the first bearing, and
a step of inserting the annular elastic seal, which is assembled on the first bearing, inside the first housing of the first flange.

According to the invention, the method further comprises:
following the insertion step, a step of introducing the annular elastic seal inside the notches.

This method for manufacturing an electromechanical actuator presents features and advantages similar to those described previously in relation to the electromechanical actuator according to the invention.

Other features and advantages of the invention will appear in the following description, made with reference to the appended drawings, given as non-limiting examples and in which:

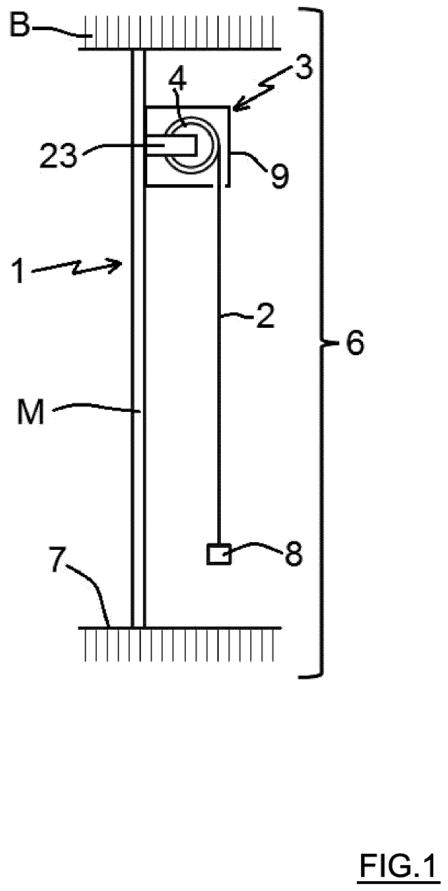

FIG. 1 is a schematic cross-sectional view of an installation comprising a shading device according to an embodiment of the invention;

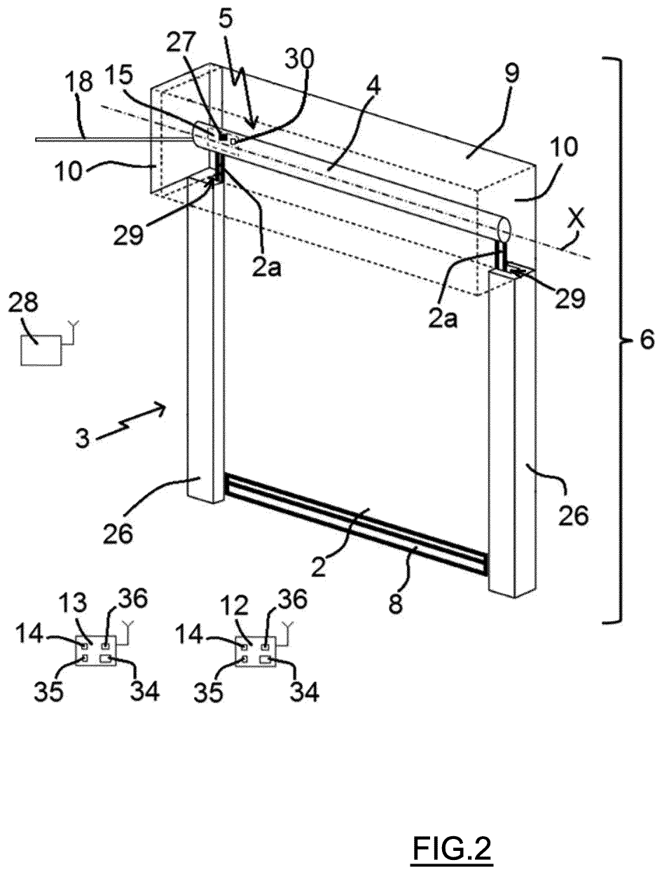

FIG. 2 is a schematic perspective view of the installation illustrated in FIG. 1;

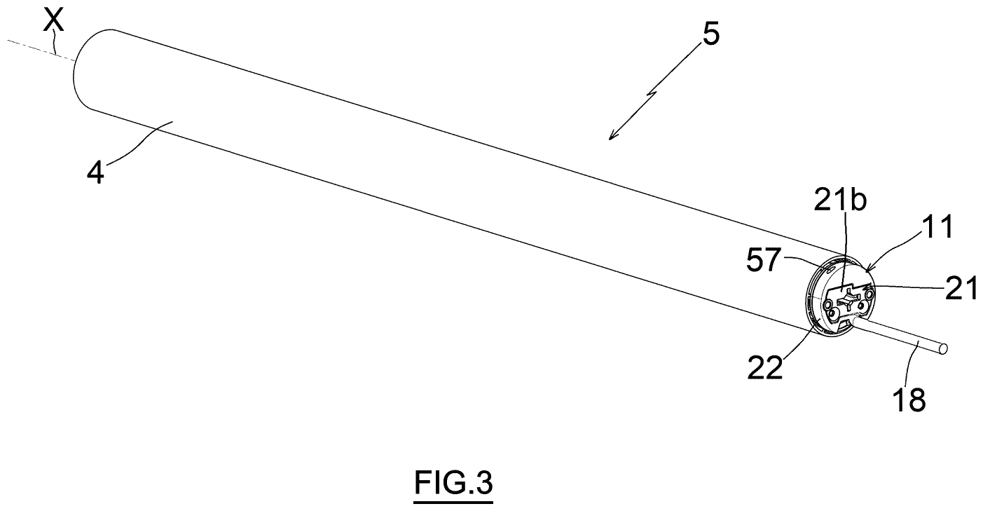

FIG. 3 is a schematic perspective view of a motorized driving device of the installation illustrated in FIGS. 1 and 2, this motorized driving device comprising an electromechanical actuator according to the invention and a winding tube;

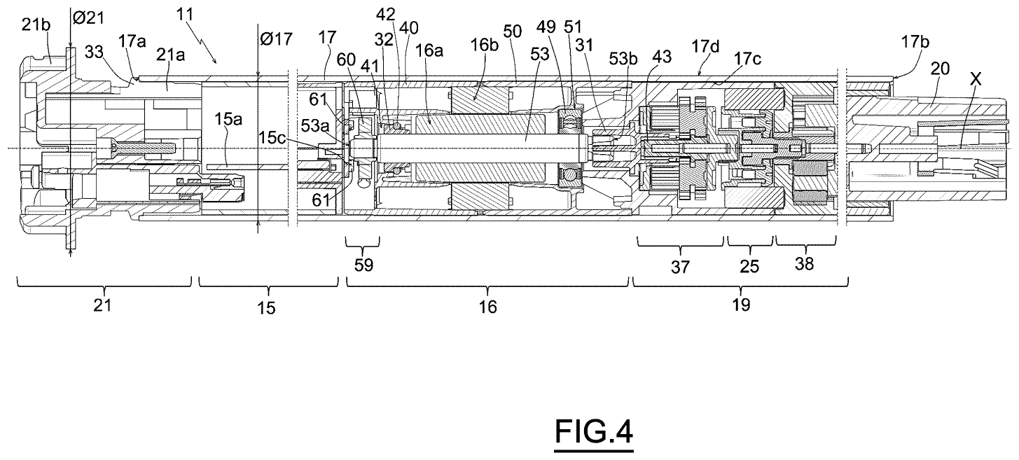

FIG. 4 is a schematic sectional view of the electromechanical actuator illustrated in FIG. 3, according to a sectional plane passing through a rotation axis of the electromechanical actuator, this schematic sectional view being locally interrupted at two parts of the electromechanical actuator;

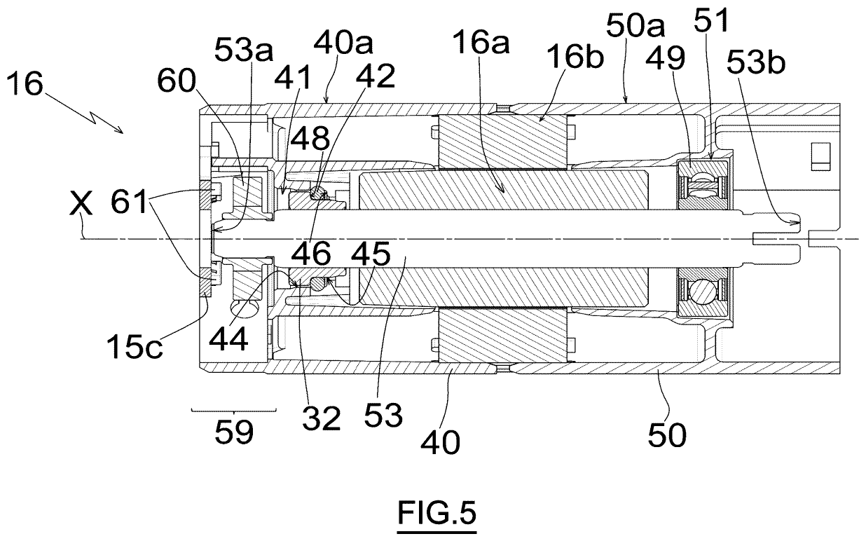

FIG. 5 is a schematic sectional view and on a larger scale of an electric motor of the electromechanical actuator illustrated in FIG. 4;

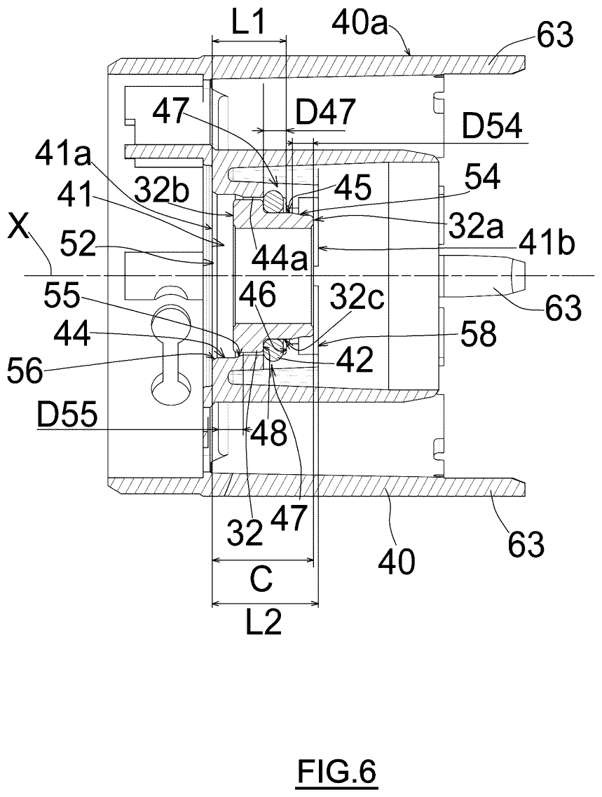

FIG. 6 is a schematic sectional view and on a larger scale of a flange of the electric motor illustrated in FIG. 5, in which a bearing and an annular elastic seal are housed, where the sectional plane passes through two notches of the flange, opposed relative to each other, and through the rotation axis;

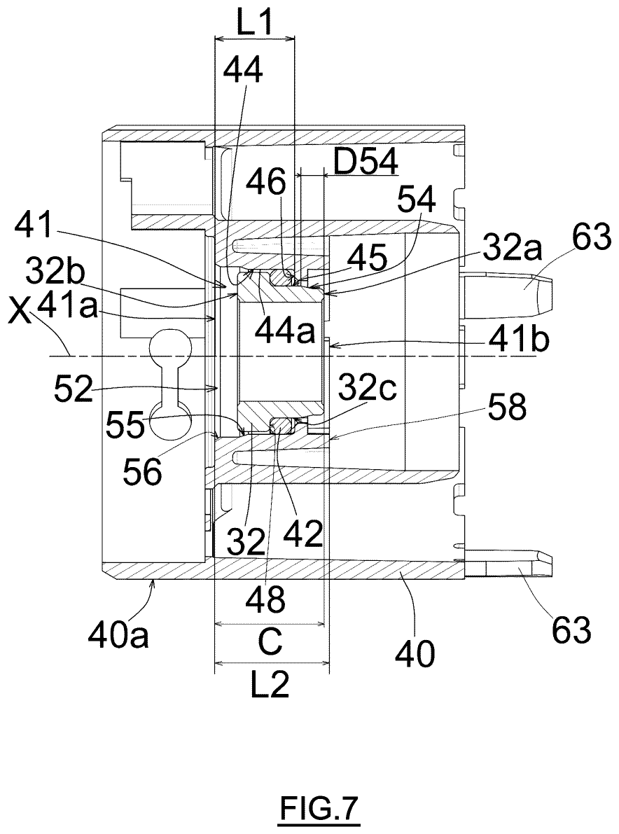

FIG. 7 is a view similar to FIG. 6, where the sectional plane is angularly offset around the rotation axis, so as not to pass through notches of the flange;

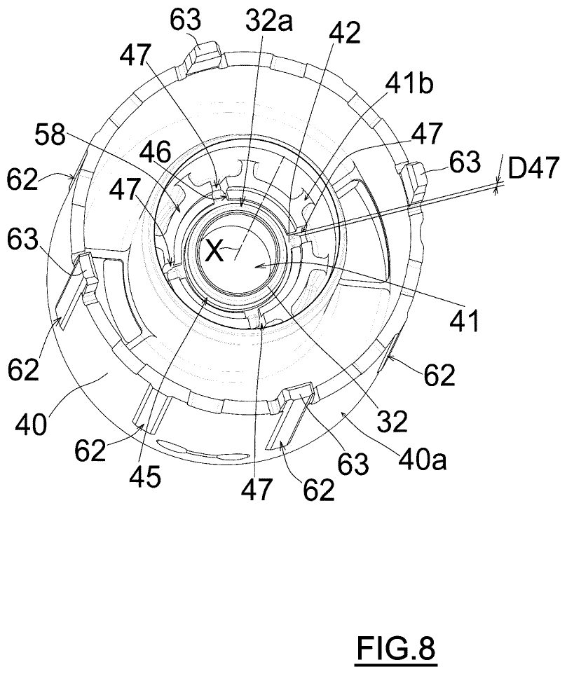

FIG. 8 is a schematic perspective view of an assembly formed by the flange, the bearing and the annular elastic seal illustrated in FIGS. 6 and 7; and

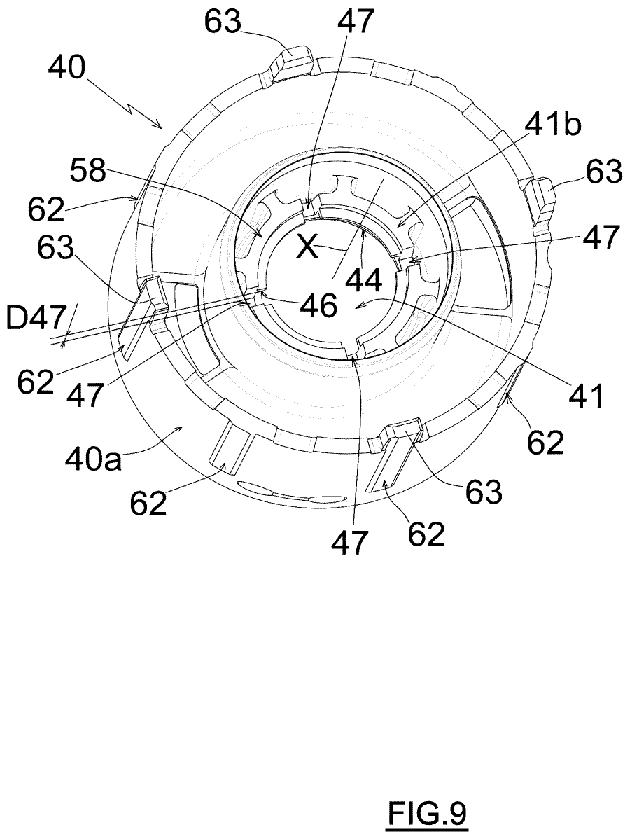

FIG. 9 is a schematic perspective view of the flange illustrated in FIGS. 6 to 8.

First of all, referring to FIGS. 1 and 2, an installation 6 comprising a closure, shading or solar protection device 3 according to an embodiment of the invention is described. This installation 6, installed in a building B, includes an opening 1, in which a window or a door is arranged, not shown. This installation 6 is equipped with a screen 2 belonging to the closure, shading, or solar protection device 3, in particular a motorized blind.

The closure, shading or solar protection device 3 is hereafter called “shading device.” The shading device 3 comprises the screen 2.

The shading device 3 can be a blind, especially a blind comprising a rollable fabric, a blind comprising a pleated or honeycomb screen or a blind with adjustable slats, or a roller shutter. The present invention applies to all types of shading devices.

Here, the installation 6 comprises the shading device 3.

A roller blind according to an embodiment of the invention is described, referring to FIGS. 1 and 2.

The shading device 3 comprises a motorized driving device 5. The motorized driving device 5 comprises an electromechanical actuator 11 illustrated in FIGS. 3 and 4.

The screen 2 is configured to be displaced, in other words is displaced, by means of the motorized driving device 5 and, more particularly, the electromechanical actuator 11.

Advantageously, the motorized driving device 5 and, consequently, the shading device 3 further comprises a winding tube 4. Furthermore, the winding tube 4 is arranged so as to be driven in rotation by the electromechanical actuator 11.

Here, the screen 2 is rollable on the winding tube 4.

Thus, the screen 2 of the shading device 3 is rolled on the winding tube 4 or unrolled around it, the winding tube 4 being driven by the motorized driving device 5, in particular by the electromechanical actuator 11.

In this way, the screen 2 is movable between a rolled-up position, in particular high, and an unrolled position, in particular low, and vice versa.

The screen 2 of the shading device 3 is a closure, shading, and/or solar protection screen, rolling and unrolling around the winding tube 4, the internal diameter of which is greater than the external diameter of the electromechanical actuator 11, so that the electromechanical actuator 11 can be inserted into the winding tube 4, during the assembly of the shading device 3.

Advantageously, the shading device 3 comprises a holding device 9, 23.

Advantageously, the holding device 9, 23 can comprise two supports 23. A support 23 is arranged at each end of the winding tube 4, in particular in an assembled configuration of the shading device 3.

Thus, the winding tube 4 is held by means of the supports 23. Only one of the supports 23 is visible in FIG. 1 and they are not shown in FIG. 2. The supports 23 allow to mechanically link the shading device 3 to the structure of the building B, especially to a wall M of the building B.

Advantageously, the holding device 9, 23 can comprise a box 9. Furthermore, the winding tube 4 and at least a part of the screen 2 are housed inside the box 9, in particular in the assembled configuration of the shading device 3.

Generally, the box 9 is arranged above the opening 1, or even in the upper part of the opening 1.

Here and as illustrated in FIG. 1, the supports 23 are also housed inside the box 9.

Advantageously, the box 9 comprises two cheeks 10, such as illustrated in FIG. 2. A cheek 10 is arranged at each end of the box 9, in particular in the assembled configuration of the shading device 3.

In a variant, represented in FIG. 2, the winding tube 4 is held by means of the box 9, in particular by means of the cheeks 10 of the box 9, without using supports, such as the supports 23 mentioned above.

Advantageously, the shading device 3 can also comprise two lateral slides 26, as illustrated only in FIG. 2. Each lateral slide 26 comprises a groove 29. Each groove 29 of one of the lateral slides 26 cooperates, in other words is configured to cooperate, with a lateral edge 2a of the screen 2, in particular in the assembled configuration of the shading device 3, so as to guide the screen 2, during the rolling and unrolling of the screen 2 around the winding tube 4.

The electromechanical actuator 11 is, for example, of the tubular type. It allows rotating the winding tube 4 around a rotation axis X, so as to displace, in particular unroll or roll, the screen 2 of the shading device 3.

In a mounted state of the shading device 3, the electromechanical actuator 11 is inserted into the winding tube 4.

Advantageously, the shading device 3 further comprises a load bar 8 to exert tension on the screen 2. The load bar 8 can also be called the final end slat.

The roller blind, which forms the shading device 3, includes a fabric, forming the screen 2 of the roller blind 3. A first end of the screen 2, in particular the upper end of the screen 2, in the assembled configuration of the shading device 3, is fixed to the winding tube 4. Furthermore, a second end of the screen 2, in particular the lower end of the screen 2, in the assembled configuration of the shading device 3, is fixed to the load bar 8.

Here, the fabric forming the screen 2 is made from a textile material.

In one embodiment, not shown, the first end of the screen 2 presents a hem through which a rod is arranged, in particular made of plastic. This hem made at the first end of the screen 2 is obtained by means of sewing the fabric forming the screen 2. During the assembly of the screen 2 onto the winding tube 4, the hem and the rod located at the first end of the screen 2 are inserted by sliding into a groove, not shown, provided on the external face of the winding tube 4, in particular along the entire length of the winding tube 4, so as to secure the screen 2 with the winding tube 4 and to be able to roll and unroll the screen 2 around the winding tube 4.

The mode of fixing the screen 2 onto the winding tube 4 is not limiting and can be different. It can be implemented, for example, by means of an adhesive or one or more joints fixed, especially by screwing or riveting, to the winding tube 4.

Whatever the embodiment, the first end of the screen 2 is arranged at the holding device 9, 23.

In the case of a roller blind, the high rolled-up position corresponds to a predetermined high end-of-travel position, or even to the bearing of the load bar 8 of the screen 2 against an edge of the box 9 of the roller blind 3, and the low unrolled position corresponds to a predetermined low end-of-travel position, or to the bearing of the load bar 8 of the screen 2 against a threshold 7 of the opening 1, or even to the complete unrolling of the screen 2.

Advantageously, the motorized driving device 5 is controlled by a control unit. The control unit can be, for example, a local control unit 12 or a central control unit 13.

Advantageously, the local control unit 12 can be connected, in a wired or wireless connection, with the central control unit 13.

Advantageously, the central control unit 13 can control the local control unit 12, as well as other similar local control units distributed in the building B.

The motorized driving device 5 is, preferably, configured to execute displacement commands, especially unrolling or rolling, of the screen 2 of the shading device 3, which can be emitted, especially, by the local control unit 12 or the central control unit 13.

The installation 6 comprises either the local control unit 12, or the central control unit 13, or the local control unit 12 and the central control unit 13.

Control means of the electromechanical actuator 11, allowing the displacement of the screen 2 of the shading device 3, are constituted by at least a control unit 15, in particular an electronic control unit.

This control unit 15 belongs to the motorized driving device 5 and, more particularly, to the electromechanical actuator 11. It is able to operate an electric motor 16 of the electromechanical actuator 11 and, in particular, to allow the supply of electrical energy to the electric motor 16.

Thus, the control unit 15 controls, especially, the electric motor 16, so as to open or close the screen 2, as described previously.

The control means of the electromechanical actuator 11 comprise hardware and/or software means.

As a non-limiting example, the hardware means can comprise at least one microcontroller 30, as illustrated in FIG. 2.

Advantageously, the control unit 15 further comprises a first communication module 27, as illustrated in FIG. 2, in particular for receiving command orders, the command orders being emitted by an order emitter, such as the local control unit 12 or the central control unit 13, these orders being intended to control the motorized driving device 5.

Advantageously, the first communication module 27 of the control unit 15 is of the wireless type. In particular, the first communication module 27 is configured to receive radio command orders.

Advantageously, the first communication module 27 can additionally or alternatively allow the reception of command orders transmitted by wired means.

Advantageously, the control unit 15, the local control unit 12, and/or the central control unit 13 can be in communication with a weather station, not shown, arranged inside the building B or remotely outside the building B, including, especially, one or more sensors that can be configured to determine, for example, a temperature, a brightness, or even a wind speed, in the case where the weather station is remotely located outside the building B.

Advantageously, the control unit 15, the local control unit 12, and/or the central control unit 13 can also be in communication with a server 28, as illustrated in FIG. 2, so as to control the electromechanical actuator 11 according to data made available at distance by means of a communication network, in particular an internet network that can be connected to the server 28.

The control unit 15 can be controlled from the local control unit 12 and/or the central control unit 13. The local control unit 12 and/or the central control unit 13 is provided with a control keyboard. The control keyboard of the local control unit 12 or the central control unit 13 comprises one or more selection elements 14 and, eventually, one or more display elements 34.

As non-limiting examples, the selection elements can be push buttons and/or touch keys. The display elements can be light-emitting diodes and/or a display, for example LCD (acronym for the Anglo-Saxon term “Liquid Crystal Display”) or TFT (acronym for the Anglo-Saxon term “Thin Film Transistor”). The selection and display elements can also be made by means of a touch screen.

Advantageously, the local control unit 12 and/or the central control unit 13 comprises at least a second communication module 36.

Thus, the second communication module 36 of the local control unit 12 or the central control unit 13 is configured to transmit, in other words transmits, command orders, in particular by wireless means, for example radio, and/or by wired means.

Furthermore, the second communication module 36 of the local control unit 12 or the central control unit 13 can also be configured to receive, in other words receives, command orders, in particular by means of the same means.

Advantageously, the second communication module 36 of the local control unit 12 or the central control unit 13 is configured to communicate, in other words communicates, with the first communication module 27 of the control unit 15.

Thus, the second communication module 36 of the local control unit 12 or the central control unit 13 exchanges command orders with the first communication module 27 of the control unit 15, either unidirectionally or bidirectionally.

Advantageously, the local control unit 12 is a control point, which can be fixed or mobile. A fixed control point can be a control box intended to be fixed on a facade of the wall M of the building B or on a face of a frame of a window or door. A mobile control point can be a remote control, a smartphone or a tablet.

Advantageously, the local control unit 12 and/or the central control unit 13 further comprises a controller 35.

The motorized driving device 5, in particular the control unit 15, is, preferably, configured to execute movement command orders, especially closure as well as opening, of the screen 2 of the shading device 3. These command orders can be emitted, especially, by the local control unit 12 or by the central control unit 13.

The motorized driving device 5 can be controlled by the user, for example by receiving a command order corresponding to pressing one or more of the selection elements 14 of the local control unit 12 or the central control unit 13.

Advantageously, the shading installation 6 further comprises at least one sensor, not shown.

Advantageously, the sensor comprises at least a second communication module 36, such as the one described with reference to the local control unit 12 or the central control unit 13. Furthermore, the second communication module 36 of the sensor is configured to communicate, in other words communicates, with the first communication module 27 of the control unit 15.

Advantageously, the sensor can be, for example, a light sensor, a temperature sensor, a humidity sensor or a wind sensor.

Thus, the motorized driving device 5 can also be automatically controlled by receiving a command order corresponding to at least one signal from the sensor.

Additionally or alternatively, the motorized driving device 5 can also be automatically controlled by receiving a command order corresponding to at least one signal from a clock, not shown, of the control unit 15, in particular the microcontroller 30.

Additionally or alternatively, the sensor and/or the clock can be integrated into the local control unit 12 or the central control unit 13.

Now, with reference to FIGS. 3 to 5, the motorized driving device 5, including the electromechanical actuator 11, belonging to the installation 6 and, more particularly, to the shading device 3 illustrated in FIGS. 1 and 2 is described in more detail.

In FIG. 4, the left and right sides of the electromechanical actuator 11 are reversed relative to FIG. 3.

The electromechanical actuator 11 comprises the electric motor 16.

The electric motor 16 comprises a rotor 16a and a stator 16b, as illustrated in FIGS. 4 and 5.

Here, the rotor 16a and the stator 16b are positioned coaxially around the rotation axis X, which is also the rotation axis of the winding tube 4 in the mounted configuration of the motorized driving device 5.

Advantageously, the electric motor 16 can be of the brushless type with electronic commutation, also called “BLDC” (acronym for the Anglo-Saxon term BrushLess Direct Current) or “synchronous with permanent magnets,” of the direct current type or of the asynchronous type.

Advantageously, the rotor 16a of the electric motor 16 comprises a shaft 53.

Advantageously, the shaft 53 comprises a first end 53a and a second end 53b. The second end 53b is opposite the first end 53a.

Advantageously, the electromechanical actuator 11 further comprises a gearbox 19.

The gearbox 19 is coupled, in other words is configured to be coupled, with the electric motor 16, in particular in an assembled configuration of the electromechanical actuator 11.

Advantageously, the electromechanical actuator 11 further comprises a torque transmission device 31.

Here, the torque transmission device 31 is constituted of a monobloc element, which can also be called a universal joint.

Here, an input shaft 43 of the gearbox 19 is coupled, in other words is configured to be coupled, with the rotor 16a of the electric motor 16 by means of the torque transmission device 31, in particular in the assembled configuration of the electromechanical actuator 11.

Advantageously, the gearbox 19 comprises one or more reduction stages 37, 38. The reduction stage 37, 38, one of the reduction stages 37, 38, or each reduction stage 37, 38 can be of the epicyclic type.

The number of reduction stages of the gearbox is not limiting. The number of reduction stages can be equal to one, two or greater than or equal to three.

Advantageously, the electromechanical actuator 11 further comprises a casing 17, in particular tubular.

Here, the electric motor 16 and, eventually, the gearbox 19 and the torque transmission device 31 are housed, in other words are mounted, inside the casing 17, in particular in the assembled configuration of the electromechanical actuator 11.

Here, the casing 17 is hollow. The casing 17 comprises a first end 17a and a second end 17b. The second end 17b is opposite the first end 17a.

Here, the casing 17 of the electromechanical actuator 11 is of cylindrical shape, especially of revolution around the rotation axis X, and is open at each of its ends 17a, 17b.

Advantageously, the casing 17 is a tube presenting a circular section.

Here, the casing 17 is made of a metallic material.

The material of the casing of the electromechanical actuator is not limiting and can be different. It can be, in particular, a plastic material.

Advantageously, the electromechanical actuator 11 further comprises a crown, not shown, which can also be called a sleeve.

The crown is arranged, in other words is configured to be arranged, near the first end 17a of the casing 17, in particular in the assembled configuration of the electromechanical actuator 11.

Advantageously, the motorized driving device 5 and, more particularly, the electromechanical actuator 11 further comprises an electrical power cable 18, as illustrated in FIGS. 2 and 3.

Advantageously, the control unit 15 can be powered by electrical energy by means of the electrical power cable 18 electrically connected to at least one power source, not shown, which can be, for example, a power supply network, especially, from the sector or from the so-called “PoE” (acronym for the Anglo-Saxon term Power over Ethernet), and/or a battery, which can be rechargeable, especially, by means of a photovoltaic panel and/or a charger, not shown, or through the power supply network.

Thus, the electrical power cable 18 allows a supply of electrical energy to the electromechanical actuator 11, in particular to the control unit 15 and the electric motor 16, from the power source(s).

Advantageously, the electromechanical actuator 11 further comprises an output shaft 20. Furthermore, the output shaft 20 of the electromechanical actuator 11 is arranged, in other words is configured to be arranged, near the second end 17b of the casing 17, in particular in the assembled configuration of the electromechanical actuator 11.

Advantageously, the output shaft 20 of the electromechanical actuator 11 is arranged inside the winding tube 4 and at least partly outside the casing 17 of the electromechanical actuator 11.

Advantageously, one end of the output shaft 20 of the electromechanical actuator 11 protrudes relative to the casing 17 of the electromechanical actuator 11, in particular relative to the second end 17b of the casing 17.

Advantageously, the output shaft 20 of the electromechanical actuator 11 is configured to drive in rotation a connecting element, not shown, connected to the winding tube 4. The connecting element is, for example, made in the form of a wheel. This connecting element is integral in rotation, around the rotation axis X, with both the output shaft 20 and the winding tube 4.

When the electromechanical actuator 11 is operated, the electric motor 16 and the gearbox 19 drive in rotation the output shaft 20 of the electromechanical actuator 11. Furthermore, the output shaft 20 of the electromechanical actuator 11 drives in rotation the winding tube 4 by means of the connecting element.

Thus, the winding tube 4 drives in rotation the screen 2 of the shading device 3, so as to open or close the opening 1.

Advantageously, the electromechanical actuator 11 further comprises a brake 25.

The brake 25 is configured to brake and/or to block in rotation the output shaft 20 of the electromechanical actuator 11, so as to regulate the rotation speed of the winding tube 4, during a displacement of the screen 2, and to keep the winding tube 4 blocked, when the electromechanical actuator 11 is electrically deactivated.

Advantageously, the brake 25 is housed, in other words is mounted, inside the casing 17 of the electromechanical actuator 11, in particular in the assembled configuration of the electromechanical actuator 11.

Here, the brake 25 is a spring brake.

In a variant, not shown, the brake 25 is a cam brake, a magnetic brake or an electromagnetic brake.

Here and as illustrated in FIG. 4, the brake 25 is configured to be arranged, in other words is arranged between two reduction stages 37, 38 of the gearbox 19, in particular between a first reduction stage 37 and a second reduction stage 38 of this gearbox 19, in particular in the assembled configuration of the electromechanical actuator 11.

In a variant, not shown, the brake 25 is configured to be arranged, in other words is arranged, in the assembled configuration of the electromechanical actuator 11, between the control unit 15 and the electric motor 16, in other words at the input of the electric motor 16, or between the gearbox 19 and the output shaft 20 of the electromechanical actuator 11, in other words at the output of the gearbox 19, or even between the electric motor 16 and the gearbox 19, that is to say at the output of the electric motor 16.

Advantageously, the electromechanical actuator 11 further comprises a device for detecting end-of-travel and/or obstacles, during the displacement of the screen 2. This device can be mechanical or electronic.

Advantageously, the device for detecting end-of-travel and/or obstacles is implemented by means of the microcontroller 30 of the control unit 15 and, in particular, by means of an algorithm implemented by this microcontroller 30.

The winding tube 4 is driven in rotation around the rotation axis X and the casing 17 of the electromechanical actuator 11 while being supported by means of two pivot connections. The first pivot connection is realized at a first end of the winding tube 4 by means of the crown. The crown thus allows a bearing to be formed. The second pivot connection, not shown, is realized at a second end of the winding tube 4, opposite the first end.

The crown forms, in other words is configured to form or constitute, a rotational guide bearing of the winding tube 4, around the casing 17 of the electromechanical actuator 11, in particular in an assembled configuration of the motorized driving device 5 and, consequently, of the shading device 3.

Advantageously, the electromechanical actuator 11 further comprises a torque support 21.

Here, the torque support 21 is arranged at the first end 17a of the casing 17 of the electromechanical actuator 11, in particular in the assembled configuration of the electromechanical actuator 11.

The torque support 21 allows to take up the forces exerted by the electromechanical actuator 11, in particular the torque exerted by the electromechanical actuator 11, relative to the structure of the building B. The torque support 21 advantageously allows, in addition, forces exerted by the winding tube 4 to be taken up, especially the weight of the winding tube 4, the electromechanical actuator 11 and the screen 2, and to ensure the transfer of these forces to the structure of the building B.

Thus, the torque support 21 allows the electromechanical actuator 11 to be fixed onto the holding device 9, 23, in particular to one of the supports 23 or to one of the cheeks 10 of the box 9.

Advantageously, the torque support 21 protrudes at the first end 17a of the casing 17 of the electromechanical actuator 11.

Advantageously, the torque support 21 closes, in other words is configured to close, the first end 17a of the casing 17, in particular in the assembled configuration of the electromechanical actuator 11.

Moreover, the torque support 21 of the electromechanical actuator 11 can allow at least a part of the control unit 15 to be supported.

Advantageously, the torque support 21 is fixed to the casing 17 by means of one or more fixing elements, not shown, in particular in the assembled configuration of the electromechanical actuator 11. The fixing element(s) can be, especially, bosses, fixing screws, elastic snap-fit fixing elements, grooves fitted into notches or a combination of these different fixing elements.

Advantageously, the torque support 21 comprises a first part 21a, which can also be called “fixed point”, and a second part 21b, which can also be called “actuator head”.

Advantageously, the first part 21a of the torque support 21 is assembled, in other words is configured to be assembled, with the casing 17, in particular in the assembled configuration of the electromechanical actuator 11. Furthermore, the second part 21b of the torque support 21 is configured to be assembled, in other words is assembled, with the holding device 9, 23, in particular in an assembled configuration of the electromechanical actuator 11 in the shading device 3.

In one embodiment, the second part 21b of the torque support 21 is assembled, in other words is configured to be assembled, on the first part 21a of the torque support 21, in particular in the assembled configuration of the electromechanical actuator 11. In this case, the second part 21b of the torque support 21 is assembled on the first part 21a of the torque support 21 by means of assembly elements.

Thus, the torque support 21 is constituted of at least two distinct pieces, each forming respectively the first and second parts 21a, 21b of the torque support 21. In this way, the second part 21b of the torque support 21 can be interchangeable relative to the first part 21a of the torque support 21, especially depending on the shape and type of the holding elements, not shown, of the holding device 9, 23.

In another embodiment, not shown, the torque support 21 can be constituted of a single piece forming the first and second parts 21a, 21b of the torque support 21. Advantageously, the second part 21b of the torque support 21 can present different external shapes, especially a splined shape, called “star-shaped,” as illustrated in FIG. 4, in other words comprising reliefs on its contour, or a round shape, in other words without reliefs on its contour, as illustrated in FIG. 3.

Advantageously, at least one portion of the first part 21a of the torque support 21 is generally of cylindrical shape and is arranged, in other words is configured to be arranged, inside the casing 17, in particular in the assembled configuration of the electromechanical actuator 11.

Advantageously, an external diameter Ø21 of at least a portion of the second part 21b of the torque support 21 is greater than an external diameter Ø17 of the casing 17.

Advantageously, the torque support 21 further comprises a stop 33. Furthermore, the stop 33 bears against, in other words is configured to bear against the casing 17, at the first end 17a of the casing 17, in particular in the assembled configuration of the electromechanical actuator 11.

Thus, the stop 33 of the torque support 21 allows to limit the insertion of the first part 21a of the torque support 21 into the casing 17, according to the direction of the rotation axis X.

Here, the stop 33 of the torque support 21 comprises a shoulder. More particularly, it is realized in the form of a collar, in particular of cylindrical shape and with a straight generatrix.

In one embodiment, the crown is arranged or inserted, in other words is configured to be arranged or inserted, around the torque support 21, in particular the first part 21a of the torque support 21, especially in the assembled configuration of the electromechanical actuator 11. In this case, the crown is mounted freely in rotation around the torque support 21, in particular the first part 21a of the torque support 21.

In a variant, not shown, the crown is arranged or inserted, in other words is configured to be arranged or inserted, around a part of the casing 17, in particular in the assembled configuration of the electromechanical actuator 11. In this case, the crown is mounted freely in rotation around the casing 17.

In another variant, not shown, the crown is arranged or inserted, in other words is configured to be arranged or inserted, on one hand, around the torque support 21 and, on the other hand, around a part of the casing 17 of the electromechanical actuator 11, in particular the first end 17a of the casing 17, especially in the assembled configuration of the electromechanical actuator 11. In such a case, the crown can be mounted freely in rotation, on one hand, around the torque support 21 and, on the other hand, around the casing 17 of the electromechanical actuator 11.

Advantageously, the torque support 21 further comprises a cover 22, as illustrated only in FIG. 3. The cover 22 is mounted, in other words is configured to be mounted, on the torque support 21, especially on the second part 21b of the torque support 21, in particular in the assembled configuration of the electromechanical actuator 11.

Advantageously, the control unit 15 is arranged at least partly inside the casing 17 of the electromechanical actuator 11.

Moreover, the control unit 15 can be arranged at least partly outside the casing 17 of the electromechanical actuator 11 and, in particular, mounted in the torque support 21 or in one of the supports 23.

Advantageously, the control unit 15 comprises a first printed circuit board 15a and a second printed circuit board, not shown.

Here, the first printed circuit board 15a of the control unit 15 is arranged inside the casing 17 of the electromechanical actuator 11, in particular in the assembled configuration of the electromechanical actuator 11. Furthermore, the second printed circuit board is arranged inside the torque support 21 of the electromechanical actuator 11, in particular in the assembled configuration of the electromechanical actuator 11.

Advantageously, the first printed circuit board 15a is configured to control the electric motor 16. Furthermore, the second printed circuit board is configured to, especially, access parameterization and/or configuration functions of the electromechanical actuator 11, by means of selection devices 57, of which only one is represented in FIG. 3, and, eventually, display devices, not shown.

Here, the control unit 15, in particular each of the first and second printed circuit boards 15a and equivalent, is supplied by electrical energy by means of the electrical power cable 18.

Advantageously, the torque support 21 comprises, in other words integrates, at least one selection device 57, as illustrated in FIG. 3, in particular a button, which can be, for example, of the pushbutton or magnetic type. Furthermore, the or each selection device 57 is configured, especially, to perform a setting of the electromechanical actuator 11 through one or more configuration modes, to pair with the electromechanical actuator 11 one or more control units 12, 13, to reset one or more parameters, which can be, for example, an end-of-travel position, to reset the paired control unit(s) 12, 13 or even to control the movement of the screen 2.

Advantageously, the torque support 21 comprises, in other words integrates, at least one display device, not shown. Furthermore, the or each display device is configured, especially, to display a visual indication, which can be, for example, representative of an operating mode of the electromechanical actuator 11, in particular a configuration mode or a control mode, or even a state of a component of the motorized driving device 5.

Advantageously, the electromechanical actuator 11 further comprises a counting device 59. The counting device 59 is configured to cooperate, in other words cooperates, with the control unit 15. Furthermore, the counting device 59 and the control unit 15 are configured to determine a position, which can be called “current,” of the screen 2.

Advantageously, the control unit 15 is configured to monitor at least one signal from the counting device 59 at a predetermined frequency, especially depending on the position of the screen 2.

Here, the counting device 59 is of the magnetic type.

In such a case, the counting device 59 can comprise a coding wheel 60 and one or more sensors 61, in particular Hall effect sensors.

Here, the coding wheel 60 is connected to the shaft 53 of the rotor 16a of the electric motor 16, in particular at the first end 53a of the shaft 53. Furthermore, the or each sensor 61 is assembled on a printed circuit board of the control unit 15, in particular on a third printed circuit board 15c, or, in a variant, on the first printed circuit board 15a.

Thus, the counting device 59 allows to determine the number of turns carried out by the rotor 16a of the electric motor 16.

Here, the counting device 59 comprises three sensors 61, of which only two are visible in FIGS. 4 and 5.

The number of sensors is not limiting and can be different. It can be, for example, equal to one or two.

In a variant, not shown, the counting device 59 can be devoid of sensors 61. In this case, the counting device 59 is configured to, in cooperation with the control unit 15, analyze the power supply command signals of the electric motor 16 and determine a position, which can be called “current,” of the rotor 16a of the electric motor 16 and, consequently, of the output shaft 20 of the electromechanical actuator 11 and the winding tube 4.

In a variant, not shown, the counting device 59 allows to determine the number of turns carried out by the output shaft 20 of the electromechanical actuator 11.

In another variant or in addition, the crown comprises, on its inner face, a toothing, not shown, configured to cooperate, in other words cooperating, with a pinion, not shown, installed inside the torque support 21 or, alternatively, inside the casing 17 of the electromechanical actuator 11. In this variant, the coding wheel 60 is connected to the pinion, in particular by means of a shaft. Thus, the toothing of the crown is configured to drive in rotation, in other words drives in rotation, the pinion, so as to count the number of turns of the winding tube 4. In this case, the toothing of the crown and the pinion are part of the counting device 59.

The counting device 59 also allows to determine the direction of rotation of the winding tube 4 and/or manage the end-of-travel positions of the screen 2.

The type of counting device is not limiting and can be different, in particular optical, for example an encoder equipped with one or more optical sensors, or temporal.

Now, with reference to FIGS. 5 to 9, the construction of the electric motor 16 is described in more detail.

The electric motor 16 further comprises a first bearing 32. The shaft 53, in particular the first end 53a of the shaft 53, is supported, in other words is configured to be supported, by the first bearing 32, in particular in an assembled configuration of the electric motor 16. The first bearing 32 comprises an external surface 45.

The electric motor 16 further comprises a first flange 40. This first flange 40 is represented alone in FIG. 9.

The first flange 40 comprises at least a first housing 41. The first bearing 32 is arranged, in other words is configured to be arranged, inside the first housing 41, in particular in the assembled configuration of the electric motor 16.

The first housing 41 comprises at least an internal surface 44, an entry opening 52, a first shoulder 46 and a plurality of notches 47. Each of the notches 47 is provided in the internal surface 44 of the first housing 41. The internal surface 44 is radial to the rotation axis X, in particular in the assembled configuration of the electric motor 16.

The electric motor 16 further comprises an annular elastic seal 42. The annular elastic seal 42 is arranged, in other words is configured to be arranged, around the first bearing 32, in particular in the assembled configuration of the electric motor 16. The annular elastic seal 42 is compressed, in other words is configured to be compressed, between the internal surface 44 of the first housing 41 of the first flange 40 and the external surface 45 of the first bearing 32, in particular in the assembled configuration of the electric motor 16.

Each of the notches 47 extends from the first shoulder 46 toward the entry opening 52 over a first predetermined distance D47, according to the direction of the rotation axis X. The first predetermined distance D47 is strictly less than a first length L1 measured between the first shoulder 46 and the entry opening 52, according to the direction of the rotation axis X.

Furthermore, the annular elastic seal 42 is introduced, in other words is configured to be introduced, inside the notches 47, in a position of the annular elastic seal 42 inserted inside the first housing 41 of the first flange 40, in other words following the insertion of the annular elastic seal 42 inside the first housing 41 of the first flange 40, or in other words in the assembled configuration of the electric motor 16, so that the annular elastic seal 42 relaxes locally inside these notches 47.

Thus, this construction of the electric motor 16 allows, on one hand, to ensure the assembly compliance of the annular elastic seal 42, which is assembled on the first bearing 32, inside the first housing 41 of the first flange 40 and, on the other hand, to minimize an operational noise level of the electric motor 16.

In this way, the annular elastic seal 42 can be inserted, in other words is inserted, from the entry opening 52 of the first housing 41 to the notches 47 provided in the internal surface 44 of the first housing 41, so that the annular elastic seal 42 relaxes locally inside these notches 47.

The notches 47 are therefore present only at the end of the insertion path of the annular elastic seal 42 inside the first housing 41 of the first flange 40. This path goes from left to right in FIGS. 6 and 7.

Consequently, these notches 47 do not cause twisting, or, eventually, tearing of the annular elastic seal 42, during the insertion of the annular elastic seal 42, which is assembled on the first bearing 32, inside the first housing 41 of the first flange 40.

Furthermore, the positioning of the annular elastic seal 42 in the notches 47 provided in the internal surface 44 of the first housing 41 ensures the maintenance in position of the first bearing 32 relative to the first housing 41, in particular according to the direction of the rotation axis X, whether during the operation of the electric motor 16 or when falling of it during a handling operation.

The positioning of the annular elastic seal 42 in the notches 47 provided in the internal surface 44 of the first housing 41 also prevents a rotation of the first bearing 32, around the rotation axis X, by adhesion of the first bearing 32 on the annular elastic seal 42.

Moreover, the compression of a part of the annular elastic seal 42 between the internal surface 44 of the first housing 41 of the first flange 40 and the external surface 45 of the first bearing 32, in other words the maintenance in position of the part of the annular elastic seal 42 outside the notches 47 provided in the internal surface 44 of the first housing 41, allows to obtain a ball joint connection and, more particularly, damping between the first bearing 32 and the first housing 41 of the first flange 40.

Advantageously, the first bearing 32 comprises a first end 32a and a second end 32b. The second end 32b is opposite the first end 32a. The second end 32b is oriented toward the entry opening 52 of the first housing 41 of the first flange 40, following the insertion of the first bearing 32 inside the first housing 41, in other words in the assembled configuration of the electric motor 16.

Advantageously, the external surface 45 of the first bearing 32 comprises a smooth part 32c and, in particular, of cylindrical shape with a circular section. Furthermore, the smooth part 32c of the external surface 45 of the first bearing 32 cooperates, in other words is configured to cooperate, with the annular elastic seal 42.

Advantageously, a part of the external surface 45 of the first bearing 32 forms an introduction slope 54, so as to introduce the annular elastic seal 42 onto the external surface 45 of the first bearing 32.

Thus, the introduction slope 54 of the external surface 45 of the first bearing 32 allows placing and centering the annular elastic seal 42 onto the external surface 45 of the first bearing 32, according to the direction of the rotation axis X.

Advantageously, the introduction slope 54 extends over a second predetermined distance D54 from the first end 32a of the first bearing 32 toward the first shoulder 46, according to the direction of the rotation axis X.

Advantageously, the internal surface 44 of the first housing 41 comprises a smooth part 44a and, in particular, of cylindrical shape with a circular section. Furthermore, the smooth part 44a of the internal surface 44 of the first housing 41 cooperates, in other words is configured to cooperate, with the annular elastic seal 42.

Advantageously, each of the notches 47 extends at least partly from the first shoulder 46 toward the entry opening 52 over all or part of the smooth part 44a of the internal surface 44 of the first housing 41, according to the direction of the rotation axis X.

Advantageously, at least a part of the internal surface 44 of the first housing 41 forms a guiding slope 55, so as to guide the annular elastic seal 42 against the internal surface 44 of the first housing 41.

Thus, the guiding slope 55 of the internal surface 44 of the first housing 41 allows centering the first flange 40 relative to the first bearing 32 via the annular elastic seal 42, according to the direction of the rotation axis X.

Advantageously, the guiding slope 55 extends over a third predetermined distance D55 from the entry opening 52 of the first housing 41 toward the notches 47, according to the direction of the rotation axis X.

Furthermore, the presence of the introduction slope 54 at the external surface 45 of the first bearing 32 and the presence of the guiding slope 55 at the internal surface 44 of the first housing 41 ensure the assembly compliance of the annular elastic seal 42, which is assembled on the first bearing 32, inside the first housing 41 of the first flange 40, that is to say without twisting and/or tearing of the annular elastic seal 42, while dispensing with a lubrication operation of the first housing 41.

Advantageously, each of the notches 47 is interrupted before the guiding slope 55 of the internal surface 44 of the first housing 41, according to the direction of the rotation axis X and in the direction of the opening 52 from the first shoulder 46.

Advantageously, the entry opening 52 of the first housing 41 comprises a chamfer 56.

Here, the chamfer 56 is an integral part of the guiding slope 55.

Advantageously, the first bearing 32 comprises a second shoulder 48. Furthermore, the annular elastic seal 42 is arranged, in other words is configured to be arranged, between the first shoulder 46 and the second shoulder 48, in particular in the assembled configuration of the electric motor 16.

Advantageously, the first bearing 32 is a bushing.

Advantageously, the annular elastic seal 42 is an O-ring.

Advantageously, the annular elastic seal 42 is made of elastomer, for example rubber.

Here, the annular elastic seal 42 presents a section of circular shape, in particular in the rest state, in other words before its assembly around the first bearing 32 and its introduction into the first housing 41.

The shape of the section of the annular elastic seal is not limiting and can be different. It can be, for example, oval or square.

Advantageously, the insertion of the first bearing 32 inside the first housing 41 of the first flange 40 is implemented according to a predetermined dimension C between the entry opening 52 of the first housing 41 and the first end 32a of the first bearing 32, in the assembled configuration of the electric motor 16. The dimension C is axial, in the sense that it is measured parallel to the rotation axis X, in particular in the assembled configuration of the electric motor 16.

Advantageously, the predetermined dimension C is less than or equal to a second length L2 measured between the entry opening 52 of the first housing 41 and a bottom end 58 of the first housing 41.

The bottom end 58 can be an exit opening or a bottom wall of the first housing 41.

Thus, the first bearing 32 does not protrude from the bottom end 58 or does not bear against the bottom end 58, following the insertion of the first bearing 32 inside the first housing 41, in other words in the assembled configuration of the electric motor 16.

Advantageously, the annular elastic seal 42 is not in contact with the first shoulder 46 of the first housing 41, following the insertion of the annular elastic seal 42 inside the first housing 41, in other words in the assembled configuration of the electric motor 16.

Thus, in this case, the first shoulder 46 of the first housing 41 is a stop, according to the direction of the rotation axis X, especially when falling of the electric motor 16 during a handling operation.

In a variant, not shown, the annular elastic seal 42 is in contact with the first shoulder 46 of the first housing 41, following the insertion of the annular elastic seal 42 inside the first housing 41, in other words in the assembled configuration of the electric motor 16.

Thus, in this case, the first shoulder 46 of the first housing 41 is a stop, according to the direction of the rotation axis X, to limit the insertion stroke of the annular elastic seal 42 and, consequently, of the first bearing 32 inside the first housing 41.

Advantageously, the electric motor 16 further comprises a second bearing 49. Furthermore, the shaft 53, in particular the second end 53b of the shaft 53, is supported, in other words is configured to be supported, by the second bearing 49, in particular in the assembled configuration of the electric motor 16.

Advantageously, the electric motor 16 further comprises a second flange 50. The second flange 50 comprises a second housing 51. Furthermore, the second bearing 49 is arranged, in other words is configured to be arranged, inside the second housing 51, in particular in the assembled configuration of the electric motor 16.

Advantageously, the second bearing 49 is a rolling bearing.

Here and as illustrated in FIGS. 4 and 5, the second bearing 49 is a ball bearing.

The type of rolling bearing forming the second bearing is not limiting and can be different. It can be, for example, roller or needle bearing.

Here, the first and second flanges 40, 50 are realized of a plastic material.

As a non-limiting example, the plastic material of the first and second flanges 40, 50 is Poly-Butylene Terephthalate, also called PBT, Polyamide 6, also called polycaprolactam or PA 6, or Polyamide 6.6, also called polyhexamethylene adipamide or PA 6.6.

Advantageously, the first flange 40, respectively the second flange 50, further comprises a plurality of tabs 63. The stator 16b comprises a plurality of notches, not shown. Each of the tabs 63 of the first flange 40, respectively the second flange 50, is inserted, in other words is configured to be inserted, into one of the notches of the stator 16b, in particular in the assembled configuration of the electric motor 16.

Thus, the first flange 40, respectively the second flange 50, is angularly oriented, in other words is indexed, relative to the stator 16b, around the rotation axis X.

Advantageously, the casing 17 comprises an internal surface 17c and an external surface 17d. The external surface 17d is opposite the internal surface 17c.

Advantageously, the first flange 40, respectively the second flange 50, comprises an external surface 40a, 50a. The first flange 40, respectively the second flange 50, comprises thickenings 62, in other words beads, provided on its external face 40a, 50a. Furthermore, each thickening 62 bears against, in other words is configured to bear against, the internal surface 17c of the casing 17, in particular in the assembled configuration of the electromechanical actuator 11.

Thus, the stator 16b is centered inside the casing 17 by means of the thickenings 62 of the first flange 40, respectively the second flange 50, according to a radial direction to the rotation axis X.

Advantageously, at least one of the thickenings 62 is aligned with one of the tabs 63 of the first flange 40, respectively the second flange 50, according to the direction of the rotation axis X.

Here, the first housing 41 comprises a first end 41a and a second end 58. The second end 58 is opposite the first end 41a. The first end 41a of the first housing 41 is arranged at the entry opening 52 of it.

Here, the bottom end 58 and the second end 58 of the first housing 41 are common.

In the embodiment illustrated in FIGS. 6 to 9, the notches 47 further extend beyond the first shoulder 46 in the opposite direction to the entry opening 52 of the first housing 41, according to the direction of the rotation axis X, in particular through the first shoulder 46 and up to the second end 41b of the first housing 41.

Thus, the manufacture of the first flange 40 is facilitated, in particular when it is obtained by an injection method of a plastic material.

In a variant, not shown, the notches 47 do not exceed the first shoulder 46, according to the direction of the rotation axis X.

Now, a method for manufacturing the electromechanical actuator 11 illustrated in FIGS. 3 to 9 is described.

The manufacturing method comprises at least the following steps, preferably executed in the mentioned order:
assembly of the annular elastic seal 42 around the first bearing 32,
insertion of the annular elastic seal 42, which is assembled on the first bearing 32, inside the first housing 41 of the first flange 40, and
following the insertion step, introduction of the annular elastic seal 42 inside the notches 47.

Advantageously, the insertion step is implemented by a pressing operation of the first flange 40 on the first bearing 32 equipped with the annular elastic seal 42.

Advantageously, the method further comprises a step of mounting the rotor 16a inside the stator 16b, where the first end 53a of the shaft 53 of the rotor 16a is inserted into the first bearing 32.

Advantageously, the assembly step comprises a sub-step of introducing the annular elastic seal 42 onto the external surface 45 of the first bearing 32, by means of the introduction slope 54.

Advantageously, the insertion step comprises a sub-step of introducing the annular elastic seal 42 inside the first housing 41 of the first flange 40, by means of the chamfer 56, and a sub-step of guiding the annular elastic seal 42 against the internal surface 44 of the first housing 41, by means of the guiding slope 55.

Thanks to the present invention, the construction of the electric motor allows, on one hand, to ensure the assembly compliance of the annular elastic seal, which is assembled on the first bearing, inside the first housing of the first flange and, on the other hand, to minimize an operational noise level of the electric motor.

Numerous modifications can be made to the embodiment and variants described above, without departing from the scope of the invention defined by the claims.

Furthermore, the contemplated embodiments and variants can be combined to generate new embodiments of the invention, without departing from the scope of the invention defined by the claims.

1. An electromechanical actuator for a shading device,
the electromechanical actuator comprising at least one electric motor,
the electric motor comprising at least
a rotor, the rotor comprising at least a shaft,
a stator, the rotor and the stator being positioned coaxially around a rotation axis,
a first bearing, the first bearing comprising an external surface, the shaft being supported by the first bearing,
a first flange, the first flange comprising at least a first housing, the first housing comprising at least an internal surface, an entry opening, a first shoulder and a plurality of notches, the first bearing being arranged inside the first housing, each of the notches being arranged in the internal surface of the first housing, and
an annular elastic seal, the annular elastic seal being arranged around the first bearing, the annular elastic seal being compressed between the internal surface of the first housing of the first flange and the external surface of the first bearing,
wherein
each of the notches extends from the first shoulder toward the entry opening over a first predetermined distance, according to the direction of the rotation axis, the first predetermined distance being strictly less than a first length measured between the first shoulder and the entry opening, according to the direction of the rotation axis,
and the annular elastic seal is introduced inside the notches, in a position of the annular elastic seal inserted inside the first housing of the first flange, so that the annular elastic seal relaxes locally inside these notches.

2. The electromechanical actuator for a shading device according to claim 1, wherein
the first bearing comprises a second shoulder,
and the annular elastic seal is arranged between the first shoulder and the second shoulder.

3. The electromechanical actuator for a shading device according to claim 1, wherein the first bearing is a bushing.

4. The electromechanical actuator for a shading device according to claim 1, wherein the electric motor further comprises
a second bearing, the shaft being supported by the second bearing, and
a second flange, the second flange comprising a second housing, the second bearing being arranged inside the second housing.

5. The electromechanical actuator for a shading device according to claim 4, wherein the second bearing is a rolling bearing.

6. The electromechanical actuator for a shading device according to claim 1, wherein a part of the external surface of the first bearing forms an introduction slope, so as to introduce the annular elastic seal onto the external surface of the first bearing, the introduction slope extending over a second predetermined distance from a first end of the first bearing toward the first shoulder, according to the direction of the rotation axis.

7. The electromechanical actuator for a shading device according to claim 1, wherein at least a part of the internal surface of the first housing forms a guiding slope, so as to guide the annular elastic seal against the internal surface of the first housing.

8. The electromechanical actuator for a shading device according to claim 1, wherein the entry opening of the first housing comprises a chamfer.

9. A shading device,
the shading device comprising at least
a screen, and
an electromechanical actuator, the screen being driven in movement by the electromechanical actuator,
wherein the electromechanical actuator is according to claim 1.

10. A method for manufacturing an electromechanical actuator for a shading device according to claim 1,
said method comprising at least:
a step of assembling the annular elastic seal around the first bearing, and
a step of inserting the annular elastic seal, which is assembled on the first bearing, inside the first housing of the first flange,
wherein said method further comprises:
following the insertion step, a step of introducing the annular elastic seal inside the notches.

11. The electromechanical actuator for a shading device according to claim 2, wherein the first bearing is a bushing.

12. The electromechanical actuator for a shading device according to claim 2, wherein the electric motor further comprises
a second bearing, the shaft being supported by the second bearing, and
a second flange, the second flange comprising a second housing, the second bearing being arranged inside the second housing.

13. The electromechanical actuator for a shading device according to claim 3, wherein the electric motor further comprises
a second bearing, the shaft being supported by the second bearing, and
a second flange, the second flange comprising a second housing, the second bearing being arranged inside the second housing.

14. The electromechanical actuator for a shading device according to claim 2, wherein a part of the external surface of the first bearing forms an introduction slope, so as to introduce the annular elastic seal onto the external surface of the first bearing, the introduction slope extending over a second predetermined distance from a first end of the first bearing toward the first shoulder, according to the direction of the rotation axis.

15. The electromechanical actuator for a shading device according to claim 3, wherein a part of the external surface of the first bearing forms an introduction slope, so as to introduce the annular elastic seal onto the external surface of the first bearing, the introduction slope extending over a second predetermined distance from a first end of the first bearing toward the first shoulder, according to the direction of the rotation axis.

16. The electromechanical actuator for a shading device according to claim 4, wherein a part of the external surface of the first bearing forms an introduction slope, so as to introduce the annular elastic seal onto the external surface of the first bearing, the introduction slope extending over a second predetermined distance from a first end of the first bearing toward the first shoulder, according to the direction of the rotation axis.

17. The electromechanical actuator for a shading device according to claim 5, wherein a part of the external surface of the first bearing forms an introduction slope, so as to introduce the annular elastic seal onto the external surface of the first bearing, the introduction slope extending over a second predetermined distance from a first end of the first bearing toward the first shoulder, according to the direction of the rotation axis.

18. The electromechanical actuator for a shading device according to claim 2, wherein at least a part of the internal surface of the first housing forms a guiding slope, so as to guide the annular elastic seal against the internal surface of the first housing.

19. The electromechanical actuator for a shading device according to claim 3, wherein at least a part of the internal surface of the first housing forms a guiding slope, so as to guide the annular elastic seal against the internal surface of the first housing.

20. The electromechanical actuator for a shading device according to claim 4, wherein at least a part of the internal surface of the first housing forms a guiding slope, so as to guide the annular elastic seal against the internal surface of the first housing.
